(19) United States
(12) Patent Application Publication
(10) Pub. No.: US 2003/0086750 A1
(43) Pub. Date: May 8, 2003

(54) Hydroelastic joint

(75) Inventor: Etienne De Fontenay, Decize (FR)

Correspondence Address: BAKER BOTTS L.L.P., 44TH FLOOR, 30 ROCKEFELLER PLAZA, NEW YORK, NY, 10112-0228, US

(73) Assignee: Michelin Recherche et Technique S.A.

(21) Appl. No.: 10/260,852

(22) Filed: Sep. 30, 2002

Related U.S. Application Data
(63) Continuation of application No. PCT/EP01/03139, filed on Mar. 19, 2001.

(30) Foreign Application Priority Data
Mar. 31, 2000 (FR) 00/04529

(51) Int. Cl. B25G 3/00; E21B 19/16

(52) U.S. Cl. 403/20

(57) ABSTRACT

A hydroelastic joint 1 comprises parallel hydraulic circuits 5, 5′, 6, 6′ that provide a different hydraulic function in different loading directions. The number and configuration of the hydraulic circuits is a function of the load profile and the behavior intended for the joint.

### CROSS REFERENCE TO RELATED APPLICATIONS

This is a continuation of international application PCT/EP01/03139, filed Mar. 19, 2001, which was published in French on Oct. 11, 2001 as international publication WO 01/75328 and which claims priority-of French publication 00/04529 filed Mar. 31, 2000.

### BACKGROUND OF THE INVENTION

1. The Field of the Invention

The present invention relates to elastic articulations containing a fluid, generally known as “hydroelastic joints”, and also concerns methods for obtaining such joints.

2. The Related Art

Such hydroelastic joints, also referred to as couplings, sleeve-joints or bushings, are used in particular in the field of automotive engineering in the suspension systems or to connect the drive aggregate to the body of the vehicle.

These hydroelastic joints, which generally consist of an internal armature essentially coaxial with an external armature interconnected by at least one deformable element, generally have a dual role. On the one hand, they allow degrees of freedom between the rigid elements they connect. On the other hand, they filter out a large proportion of the vibrations or shocks transmitted from the road or from the engine to the body of the vehicle. To improve the damping performance, a liquid circulates through channels between working chambers as a function of the deformations imposed on the joint. The inertia of the liquid produces reaction forces whose characteristics vary as a function of the frequency of the loads imposed. In general, the effect of the reaction forces is measured by the phase shift angle introduced between the loads and the resultant of the reaction forces. Another characteristic parameter is the frequency at which the dynamic rigidity of the joint is minimal. By choosing the characteristics of the working chambers, the channels and the deform able elements, the response of a hydroelastic joint can be adapted to a given load profile (frequency, amplitude, direction). This gives a clear improvement of the damping compared with a conventional joint containing no liquid.

A hydroelastic joint, however, is generally subjected to different loads in several directions, and different responses may be desired (and thus different characteristics according to load directions). A difficulty in designing hydroelastic joints is to enable these specific characteristics to exist independently of one another. It is not infrequently the case that the advantages given by a specific design in one direction are lost when parameters which are a priori related to performance in a different direction are modified. Very different behaviors in different directions are not necessarily independent, indeed far from it.

In the same way, a hydroelastic joint is often subjected to loads whose frequency and amplitude vary with time in each direction, and it is desirable to have responses adapted to the widest possible load range. That is to say, it would be desirable to be able to tune several operating points within that range without having to accept that performance at any one point must suffer in order to improve performance at another.

### SUMMARY OF THE INVENTION

Accordingly, one object of the invention is to provide a hydroelastic joint which enables different behaviors depending on the directions and types of loads, while at the same time the interdependence of these various behaviors is limited.

In accordance with the invention, this object is achieved by a hydroelastic joint comprising essentially coaxial internal and external armatures, the armatures being attached to an elastomer sleeve which comprises along its axis hydraulic circuits which are essentially parallel.

### BRIEF DESCRIPTION OF THE DRAWINGS

The various principles of the invention and preferred embodiments thereof will be better understood by reference to the description of the following figures, in which:

FIG. 1 is a radial section of one embodiment of a hydroelastic joint according to the invention;

FIG. 2 is a section along the axis of the embodiment of FIG. 1;

FIG. 3 is a radial section of another embodiment of a hydroelastic joint according to the invention;

FIG. 4 is a section along the axis of the embodiment of FIG. 3;

FIG. 5 is a perspective view of a basic structural element of a hydroelastic joint according to the invention; and

FIG. 6 is a section along the axis of another embodiment of a hydroelastic joint according to the invention.

### DESCRIPTION OF EXEMPLARY EMBODIMENTS

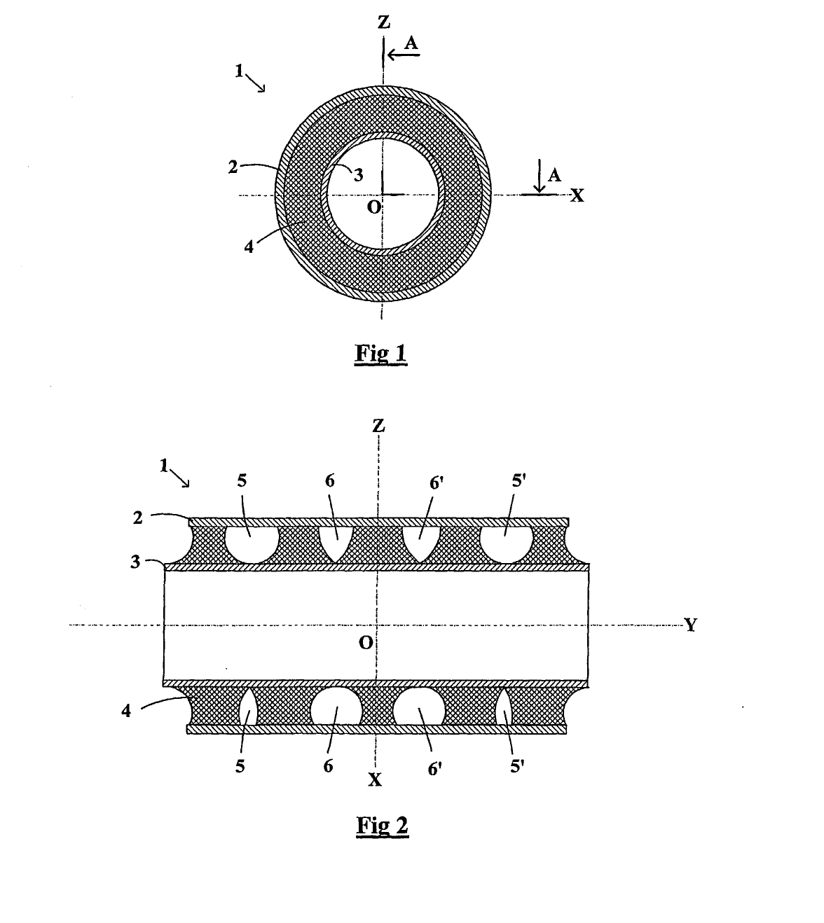

FIG. 1 is a radial section of one embodiment of a hydroelastic joint 1 according to the invention. An internal armature 3 and an external armature 2 are connected by an elastomeric sleeve 4. Thus, one armature can move both radially and axially relative to the other.

FIG. 2 is a section along the broken line ZOX of the hydroelastic joint 1 of FIG. 1, viewed in the direction A-A. In this example, the hydroelastic joint comprises four main independent hydraulic circuits 5, 5′, 6, 6′ arranged essentially parallel to one another, i.e. juxtaposed, along the axis OY. The term “hydraulic circuit” means a circuit comprising at least two chambers and at least one channel connecting these chambers. The schematic representation of FIG. 2 indicates the cross-sectional variations of the different circuits. From the figure, it is apparent that the circuits 5, 5′ at both ends of the joint have a reduced cross section in the plane OXY (horizontal plane in FIG. 1). This reduction of cross section directly influences the vibratory behavior of the joint along the axis OZ (vertical radial axis in FIG. 1). The circuits 6, 6′ in this case located at the center of the joint have a reduced cross section in the plane OYZ (the vertical axial plane in FIG. 1). This cross-sectional reduction directly influences the vibratory behavior of the joint along the axis OX (horizontal radial axis in FIG. 1). In this way, the hydroelastic joint of the invention combines different behaviors along the different load axes, and these behaviors are relatively independent.

The shapes of the hydraulic circuits are here described in an entirely schematic way, and the axes are chosen arbitrarily to illustrate the principle of the invention. In particular, the annular projections of the elastomer sleeve 4 may have any shape appropriate for hydraulic operation and for the transmission of mechanical forces (radial compression, axial torsion, conical torsion, etc.). A skilled person in the art will understand how to configure the chambers and the channels connecting them as a function of the response desired along a given direction and for a given load profile. The number of circuits needed can also be varied, and it is easily understood that it depends in particular on the complexity of the load profile envisaged.

For example, the joint of the invention as shown in FIG. 2 may have a dynamic stiffness along the direction OX which is minimal at around 250 Hz (for example, to limit the transmission of tire vibrations to the body), and may also have a dynamic stiffness along the direction OZ which is also minimal at around 100 Hz (for example, to limit the transmission of vibration generated by a suspension system assembly to the body).

Another interesting example of the adaptation of the hydroelastic joint according to the invention is that the circuits can be configured so as to procure different minimum dynamic rigidities in essentially identical directions, such that by superimposition of the different responses of each circuit an overall response of the joint is obtained, having a large frequency range in which the rigidity is essentially minimal. No such result is possible with joints of the prior art.

A joint according to the invention may of course combine a large number of circuits and integrate both of the adaptation modes described above. Thus, each direction corresponding to an identified loading mode may be associated with one, two or several similar or different hydraulic circuits, depending on the response desired.

To influence the hydraulic operation during conical deformations (relative rotation of the armatures around, for example, the axis OX), channels may connect adjacent circuits, for example along the external armature 2 or through ducts passing through the annular projections of the elastomer sleeve 4. The presence of such communication between circuits can also facilitate the operation of filling the joint with liquid.

The circuits are represented here as loops, i.e. they form a ring around the axis of the joint, but this configuration is not limiting. In effect, the principle of hydraulic operation, known in itself, applies in similar fashion if the ring is interrupted. Moreover, each circuit may extend over less than one turn or, on the contrary, over more than one turn around the axis of the joint, so that the hydraulic liquid channel may be given the desired dimensions. In this case, for example for reasons related to available space or to production, the circuits may be configured slightly obliquely relative to the axis of the joint.

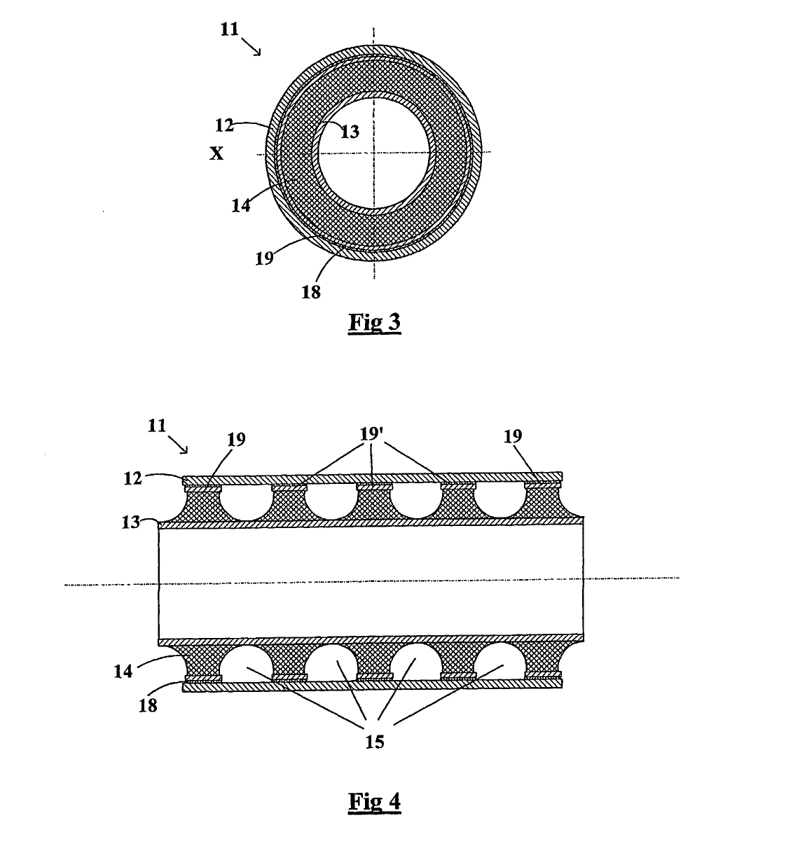

FIGS. 3 to 6 show preferred embodiments of a hydroelastic joint 11, 21 according to the invention. For the sake of clarity, the figures do not show any cross-section variation. Such a configuration may operate hydraulically in a satisfactory way in certain applications, but it is clear that the section variations envisaged and described above can be obtained by these preferred modes of fabrication.

FIGS. 3 and 4 are views similar to those of FIGS. 1 and 2. The elastomer sleeve 14 can be molded or extruded onto the internal armature 13 in one or more operations from a single material or a different material for each annular projection. The rigid rings 19, 19′ (additional compared to FIGS. 1 and 2) can be bonded to the annular projections in a known way. These rigid rings 19, 19′ allow the external armature 12 to be seated (in a way known as such) by permanent radial compression. Preferably, a sealing 18 ensures that the hydraulic circuits are leakproof. This sealing may be formed during the molding of the elastomeric sleeve 14. As the figures suggest, the assembly of the elastomeric sleeve 14, the internal armature 13 and, where appropriate, the rigid rings 19, 19′ may be carried out in large lengths or even continuously (infinite length). The length required for a given joint may then be cut off and the external armature 12 seated on it by swaging. The hydraulic circuits 15 can be filled, for example, by suction through orifices made in one or other of the armatures, or by immersion during the fitting of the external armature. Although it is essential that the ends of the joint are leakproof, this may not be essential between the circuits. For that reason, the three central rigid rings 19′ shown here may be omitted in an alternative version.

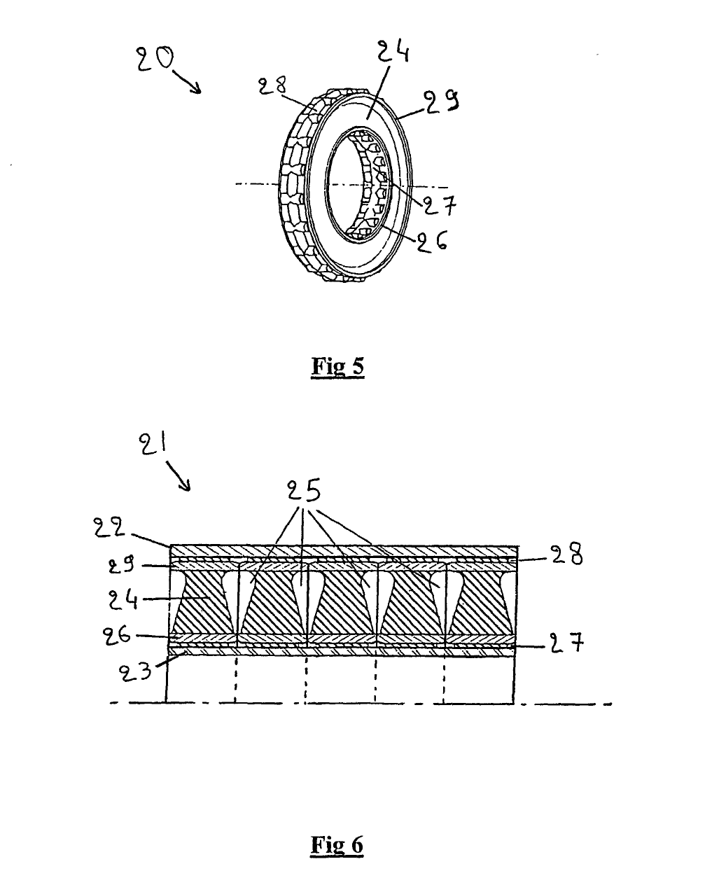

FIGS. 5 and 6 show another manufacturing method. FIG. 5 is a perspective view of a basic element 20. FIG. 6 is a half-view in axial section of a hydroelastic joint 21 consisting of a plurality of basic elements 20 arranged axially adjacent to one another and forming between them independent hydraulic circuits 25. The basic element 20 has an internal sub-armature 26 and an external sub-armature 29 connected by an elastomeric sleeve 24. External and internal sealing joints 28, 27 are attached to the corresponding sub-armatures. As shown in FIG. 6, the basic elements 20 are assembled via an internal armature 23 and an external armature 22. As described above, the connections are effected by swaging, press-fitting, gluing, vulcanization-bonding bonding or in any other known way. The profile of the sleeves 24 forms a hydraulic circuit 25 between two adjacent or spaced elements 20.

It is easy to understand the advantage of this method of implementing the invention, which allows a variable number of different basic elements 20 to be assembled with freely chosen orientations and spacings. Naturally, a great diversity of profiles, thickness, nature, rigidity or height of the sleeves 24 can be used. Thus, both at the design stage and in small-series manufacture, this modularity allows important optimization. In the case of a joint which also acts as a torsion spring (see above), this greater freedom of adaptation can be particularly useful for establishing all the vibratory parameters of a vehicle in the tuning phase, in parallel with the adaptation of the torsional stiffness.

Alternatively, as described earlier in relation to FIG. 1, each basic element 20 can comprise one or more hydraulic circuits within the bulk of its sleeve 24. The joint of the invention is then made up from a plurality of basic elements each having a hydroelastic function of its own that confers the desired behavior upon the assembly as a whole. Naturally, this configuration can be combined with that described in the previous paragraph, with or without hydraulic communication between the circuits belonging to each basic element and the cavities formed between adjacent elements.

Preferably, besides its connecting and damping role described at the beginning, the joint according to the invention is also designed to act as a torsion spring, for example in the context of the suspension of a wheel arm of the type described in U.S. Pat. No. 6,074,016. Thus, it may be desired to obtain a hydroelastic joint which is at one and the same time extremely rigid in torsion around its axis, relatively rigid in axial translation, and has very low static and dynamical stiffnesses in radial translation. This is achieved by the configurations described in the figures where the section subjected to torsion is only slightly reduced compared with a monoblock component, but the radial rigidity is considerably reduced by virtue of the hydraulic cavities in the elastic sleeve, these cavities preventing saturation of the rubber.

Naturally, the cross-section of a hydroelastic joint according to the invention is not limited to a circular profile as illustrated in the figures. Although that configuration is most common, the same effects of the principles of the invention can be achieved with joints having other profiles.

Although the invention has been described and illustrated herein by reference to specific embodiments thereof, it will be understood that such embodiments are susceptible of variation and modification without departing from the inventive concepts disclosed. All such variations and modifications, therefore, are intended to be encompassed within the spirit and scope of the appended claims.

What is claimed is:

1. A hydroelastic joint, comprising:
an elastomeric sleeve having an axis of elongation and internal and external surfaces;
an internal armature coupled to the internal surface of the elastomeric sleeve;
an external armature coupled to the external surface of the elastomeric sleeve; and
a plurality of essentially parallel hydraulic circuits in said elastomeric sleeve spaced along the axis thereof.

2. The hydroelastic joint according to claim 1, wherein said joint comprises a suspension spring loaded in torsion about its axis.

3. The hydroelastic joint according to claim 1, wherein:
said joint comprises a plurality of basic elements arranged axially adjacent to one another between said internal armature and said external armature, each basic element comprising an external sub-armature and an internal sub-armature attached to an axial segment of said elastomeric sleeve;
said external sub-armature and said internal sub-armature being coupled to said external armature and said internal armature, respectively; and
said hydraulic circuits are formed between axially adjacent ones of said basic elements.

4. The hydroelastic joint according to claim 1, wherein the hydraulic circuits are configured so as to show dynamic stiffness minima in different loading directions.

5. The hydroelastic joint according to claim 1, wherein the hydraulic circuits are configured so as to show different dynamic rigidity minima along an essentially common loading direction.
